(19) United States
(12) Patent Application Publication
(10) Pub. No.: US 2007/0240317 A1
(43) Pub. Date: Oct. 18, 2007

(54) Scribe and guide system

(76) Inventor: Michael Nicholson, Upper Darby, PA (US)

Correspondence Address: John A. Parrish;Law Offices of John A. Parrish, Suite 300, Two Bala Plaza, Bala Cynwyd, PA, 19004, US

(21) Appl. No.: 10/880,747

(22) Filed: Jun. 28, 2004

(51) Int. Cl. B43L 13/00

(52) U.S. Cl. 33/32.3

(57) ABSTRACT

A scribe and guide system is disclosed. The scribe and guide system may be configured to achieve a variety of scribe and guide devices.

### FIELD OF THE INVENTION

The invention relates to systems for scribing and marking of materials.

### BACKGROUND OF THE INVENTION

Numerous scribing devices are known in the art. These devices, however, they suffer from the disadvantage of time consuming set up procedures. A need therefore exists for scribing systems which are flexible and avoid the disadvantages of the prior art.

### BRIEF DESCRIPTION OF THE DRAWINGS

FIG. 1 is an exploded view of the scribe and guide system that shows a rear view of the body member component of the system.

FIG. 1A. is a front view of the body member of the scribe and guide system shown in FIG. 1.

FIG. 1B. is a side view of the body member of FIG. 1A taken in the direction of arrows A-A.

FIG. 2 is a front view of an embodiment of the scribe and guide system which shows a marking member, a guide member located at an end of body member, and a scribe head.

FIG. 3 is a front view of an embodiment of the scribe and guide system which shows a marking member and an arc-circle making head.

FIG. 4 is a front view of an embodiment of the scribe and guide system where the guide member is positioned near the center of the body member and the marking member is located at an end of the body member.

### DETAILED DESCRIPTION OF THE INVENTION

The invention generally relates to a scribe and guide system. The components of the scribe and guide system may be configured to achieve a variety of scribe and guide devices as described below. Each of the components may be made by a variety of known processes such as injection molding, casting, extrusion and the like.

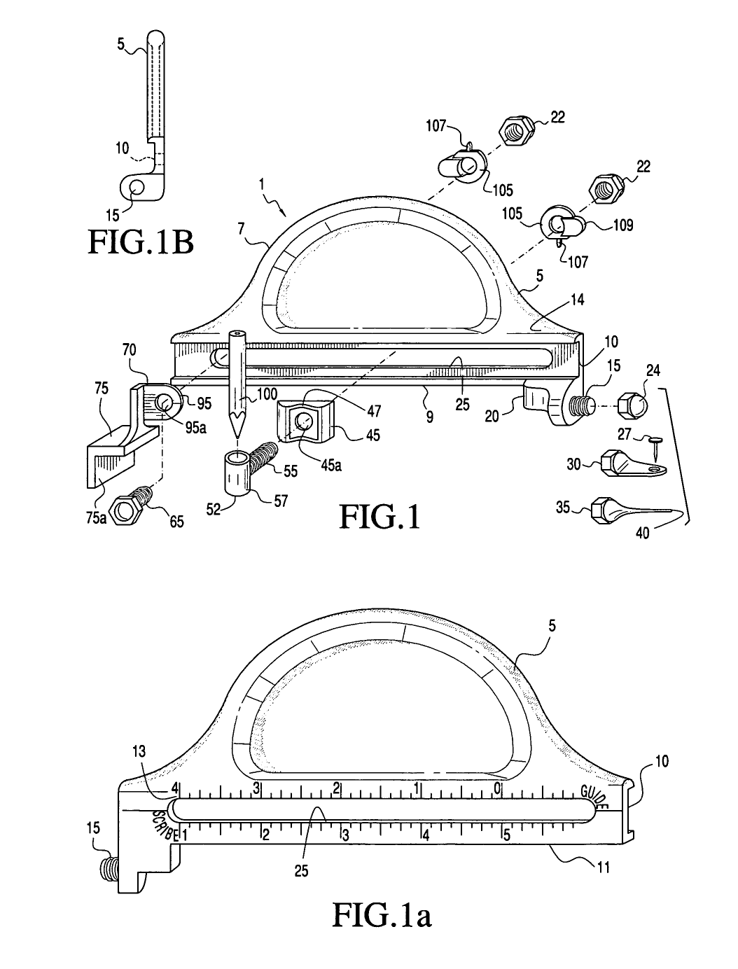

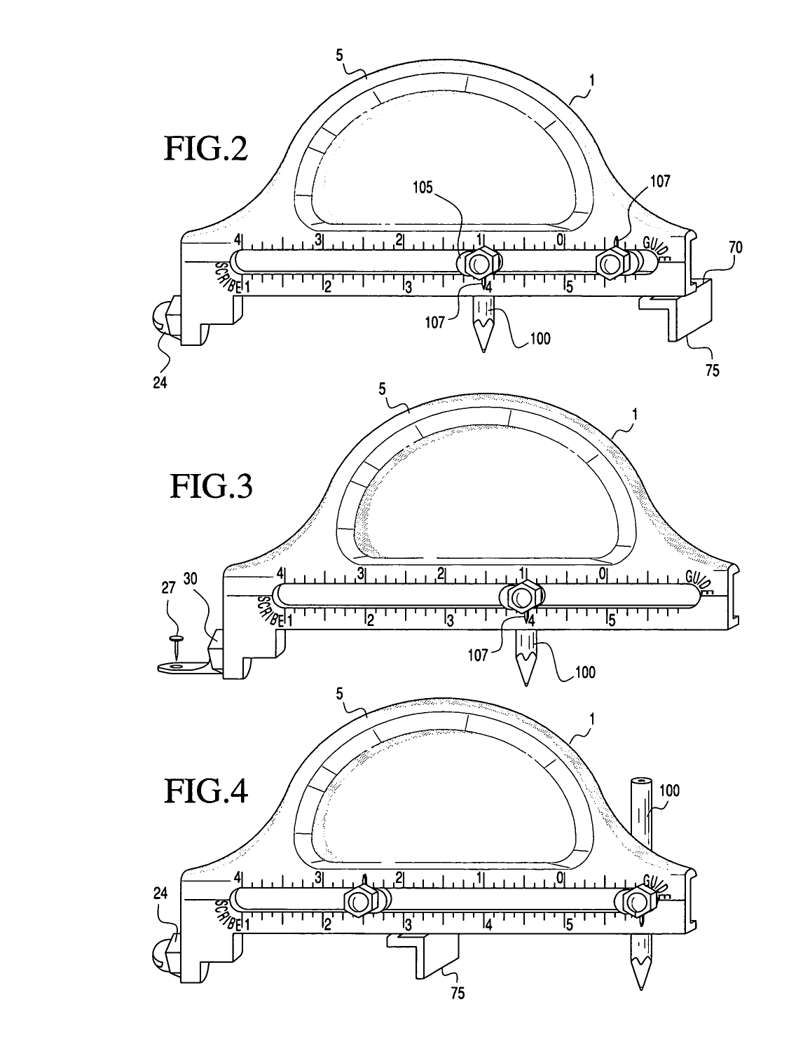

A first embodiment of the scribe and guide system is shown in FIGS. 1 and 2. As shown therein, scribe and guide system 1 includes body number 5 formed of handle section 7 and integral elongated section 9. Front face 11 of elongated section 9 preferably includes a graduated scale 13 thereon for locating the position of marking member 100 and guide 70. Elongated section 9 includes groove 10 which preferably runs the length of elongated section 9. Elongated section 9 includes support section 20 within which receiving rod 15 is located. Preferably, rod 15 is threaded.

Groove 10, located in rear face 14 of elongated section 9 as shown in FIG. 1, receives marking member holder 45 and lateral section 95 of guide 70. Marking member holder 45 is dimensioned to fit into and be movable in groove 10. Marking member holder 45 has hole 45A for receiving rod 55 of gripping member 52. Preferably, rod 55 is threaded. Gripping member 52 includes clasp 57 which preferably is integral with rod 55. Marking member holder 45 includes curved section 47 that has a radius of curvature that is approximately equal to that of clasp 57.

Marking member 45, preferably with marking member 100 in clasp 57, is placed in groove 10. Marking member holder 45 is joined to elongated section 9 by passing rod 55 through hole 45A, and through elongated slot 25. Pointer member 105 then is placed on rod 55,and nut 22 then is secured to rod 55 to retain marking member holder 45 in a desired position.

Pointer member 105 includes alignment pointer 107 and slide section 109. Slide section 109 is dimensioned to fit into and be movable in slot 25. Alignment pointer 107 can be used to precisely locate the position of marking member 100.

Guide 70 includes lateral section 95 and guide surfaces 75, 75A. Lateral section 95 is dimensioned to fit snugly within groove 10 while permitting movement of guide 70 within groove 10. Guide 70 is attached to elongated section 9 by first placing lateral section 95 of guide 70 into groove 10. Subsequently, a fastening means such as screw 65 is passed through hole 95A in lateral section 95, and then through elongated slot 25. Pointer member 105 then is placed over screw 65. Nut 22 then is applied to screw 65 to retain guide 70 at a desired position Alignment pointer 107 can be used to precisely locate the position of guide 70.

Various types of scribe heads 24,35, as well as arc-circle making head 30, can be joined to rod 15. As shown in FIG. 1, two types of scribe heads are illustrated. Scribe head 24 may be used to transfer surfaces which have gradual contours and which are free of steep setbacks. Scribe head 35 may be used to transfer surfaces which have steep setbacks and contours up to about one inch below the horizontal.

When scribe head 35 is attached to rod 15, leading edge 40 of scribe head 35 contacts the surface being scribed. Leading edge 40 rides on the surface of the material that is being scribed while main body 5 is maintained perpendicular to that surface.

During movement of the device, pressure is applied to marking member 100 so that a legible line is made on the material onto which the scribed surface is to be transferred.

FIG. 2 shows a second embodiment of the scribe and guide system. In this embodiment, guide member 70 is located at an end of slot 25 and marking member 100 is located at a position within slot 25. The device of this second embodiment may be used to scribe irregular surface contours onto materials for cutting and fitting. As an example, irregular wall contours may be scribed onto the mating edges of a countertop.

In a third embodiment, as shown in FIG. 3, arc-circle making head 30 is placed on rod 15 without guide 70. Arc-circle making head 30 is joined to rod 15. Arc-circle making head 30 is located at a desired position on a material, and pin 27 is caused to penetrate that material to anchor the scribe-guide device. The scribe device of this embodiment then may be used to make circles and arcs by rotating body member 5 around pin 27. The device of this embodiment may be used, for example, to make arcs and circles on a material to mark patterns for ceiling fixtures and valances, stair “first tread” patterns, “end arcs” for arch entries and rounded corners on countertops. This embodiment of the scribe and guide system may be used on irregular surfaces where guide 70 might prevent marking member 100 from being able to continuously mark a surface.

In a fourth embodiment, as shown in FIG. 4, marking member 100 is at an end of the device and guide 70 is located at a desired position by using alignment pointer 107. The device of this embodiment may be used in areas with restricted setback distances such as plaster wall returns on either side of a window. In use, guide surface 75 is maintained against the edge of an object such as a window jamb. While maintaining contact with that edge, pressure is applied to marking member 100 so that it makes a legible mark onto the surface for which a molding setback distance from the edge of the object is marked.

The device of this fourth embodiment may be used to mark distances from the outside edge of a material for use on molding alignments, off-edge fastener locations, metal bending locations on a bending brake, and hardware alignments on doors and drawers.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

1. A scribe and guide system comprising a body member 5 having a handle section 7 and integral elongated section 9, wherein elongated section 9 has a front face 11 that includes graduated scale 13, wherein elongated section 9 includes groove 10 that has a length that is about equal to the length of elongated section 9, wherein elongated section 9 includes a support section 20 that includes a threaded receiving rod 15 therein.
